(19) United States
(12) Patent Application Publication
(10) Pub. No.: US 2013/0097533 A1
(43) Pub. Date: Apr. 18, 2013

(54) USER TERMINAL DEVICE AND METHOD FOR CONTROLLING A RENDERER THEREOF

(71) Applicants: Ray Hong, Seoul (KR); Sahng-hee Bahn, Yongin-si (KR); Chang-hwan Hwang, Seoul (KR); Jong-chan Park, Uiwang-si (KR); Ju-yun Sung, Yongin-si (KR); Keum-koo Lee, Seongnam-si (KR)

(72) Inventors: Ray Hong, Seoul (KR); Sahng-hee Bahn, Yongin-si (KR); Chang-hwan Hwang, Seoul (KR); Jong-chan Park, Uiwang-si (KR); Ju-yun Sung, Yongin-si (KR); Keum-koo Lee, Seongnam-si (KR)

(73) Assignee: Samsung Electronics Co., Ltd., Suwon-si (KR)

(21) Appl. No.: 13/610,189

(22) Filed: Sep. 11, 2012

(30) Foreign Application Priority Data
Oct. 14, 2011 (KR) 10-2011-0105485

(51) Int. Cl. G06F 3/048

(52) U.S. Cl. 715/762

(57) ABSTRACT

A method for controlling a renderer of a user terminal device includes selecting a renderer which shares contents, transmitting contents to the selected renderer, displaying a control User Interface (UI) including an object image of which position moves according to a user's touch manipulation, and performing a control operation which controls the renderer in accordance with movements of the object image on the control UI. Accordingly, renderer operations can be easily controlled.

### PRIORITY

This application claims priority under 35 U.S.C. §119 from Korean Patent Application No. 10-2011-0105485, filed on Oct. 14, 2011, in the Korean Intellectual Property Office, the contents of which are incorporated herein by reference.

### BACKGROUND OF THE INVENTION

1. Field of the Invention

The present invention relates generally to a user terminal device and a method for controlling a renderer thereof, and more particularly, to a user terminal device for controlling a renderer using an object image and a method for controlling the renderer thereof.

2. Description of the Related Art

Various advanced electronic devices have been developed in the recent evolution of electronic technology. There has particularly been a proliferation in the development of advanced user terminal devices, such as a smart phone and smart TeleVision (TV).

Users can connect their user terminal devices to peripheral devices in a network, such as by using DLNA (Digital Living Network Alliance). The DLNA provides a simple manner for sharing music, photos, and videos between several different devices.

In using DLNA, a device which provides contents is a Digital Media Server (DMS) and a device which plays the provided contents is a Digital Media Renderer (DMR) or Digital Media Player (DMP). For the sake of convenience, DMR and DMP are collectively known as the renderer in the present invention.

Further, a device that controls the content playing device is a Digital Multimedia Controller (DMC). If a user selects a content sharing function using a user terminal device, the user terminal device can perform the DMC function.

In order to perform the DMC function, conventional user terminal devices display a User Interface (UI) including various buttons. Therefore, the user can be distracted by the UI instead of watching the renderer to be controlled, causing difficulty in controlling the device.

Accordingly, there is a need in the art for methods for users to efficiently and conveniently control the renderer in user terminal devices.

### SUMMARY OF THE INVENTION

Embodiments of the present invention address at least the above problems and/or disadvantages and other disadvantages not described above.

The present invention provides a user terminal device to efficiently and conveniently control a renderer according to manipulated matters by displaying an object image to be manipulated by users, and a method for controlling the renderer of the user terminal device. According to an embodiment of the present invention, there is provided a method for controlling a renderer of a user terminal device, including selecting a renderer to share contents, transmitting the contents to the selected renderer, displaying control UI including an object image of which position is moved according to user's touch manipulation, and controlling the renderer according to the movements of the object image on the control UI.

According to an aspect of the present invention, there is provided a method further including displaying a background image, displaying contents stored in at least one device of the user terminal device and other devices connected in a network if an icon corresponding to a content sharing function is selected on the background image, playing, if one content is selected from the displayed contents, the selected content, and displaying a device list when a renderer selection menu is selected.

According to an aspect of the present invention, there is provided a user terminal device including a storage unit which stores contents, a UI unit which outputs UI to select a renderer to share the contents, an interface unit which transmits the contents to the renderer selected in the UI, and a control unit which controls the UI unit to display a control UI including an object image whose position moves according to users' touch manipulations if the contents are transferred. If the object image moves on the control UI, according to movements of the object image, the control unit may perform a control operation to control the renderer.

According to aspects of the present invention, it is possible to conveniently control operations of a renderer without watching the renderer playing contents.

### BRIEF DESCRIPTION OF THE DRAWINGS

The above and/or other aspects of the present invention will be more apparent by describing embodiments of the present invention with reference to the accompanying drawings, in which:

FIG. 1 illustrates a constitution of a content sharing system according to an embodiment of the present invention;

FIG. 2 illustrates a constitution of a user terminal device according to an embodiment of the present invention;

FIG. 3 illustrates an example of a UI constitution to perform a content sharing function;

FIGS. 4 to 8 illustrate control UI constitutions and methods for operating the control UI according to embodiments of the present invention;

FIG. 9 illustrates an object image manipulation and an example of a control operation according to the object image manipulation;

FIGS. 10 and 11 illustrate a method for sharing contents according to embodiments of the present invention; and

FIG. 12 illustrates another example of the UI constitution to perform a content sharing function.

### DETAILED DESCRIPTION OF EMBODIMENTS OF THE INVENTION

Embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the present invention can be performed without those specifically defined matters. Also, well-known functions or constructions are not described in detail for the sake of clarity and conciseness.

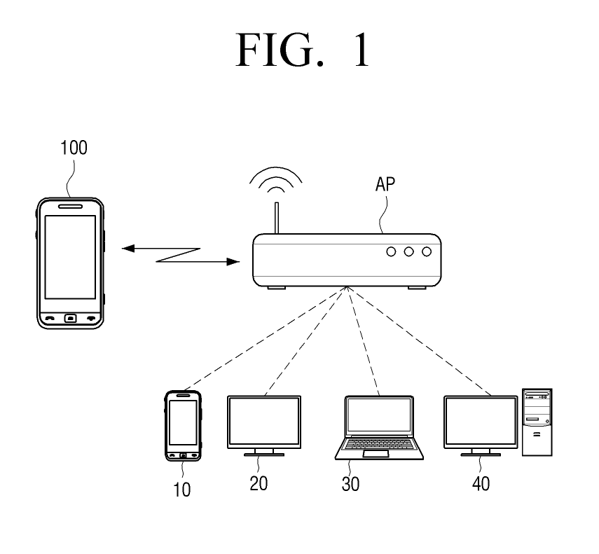

FIG. 1 illustrates a constitution of a content sharing system according to an embodiment of the present invention. Referring to FIG. 1, the content sharing system comprises a user terminal device 100, an Access Point (AP), and a plurality of devices 10, 20, 30, 40. The user terminal device and each device 10, 20, 30, 40 form a network through the AP. FIG. 1 illustrates a network structure connected by the AP, and may be applied to an environment of a network wherein devices are directly connected.

If a content sharing function is selected in the user terminal device 100, the user terminal device 100 searches each device 10, 20, 30, 40 which is connected to a network through the AP. The content sharing function can play by involving DLNA, i.e., by sharing contents among a plurality of devices.

In performing the content sharing function, the user terminal device 100 may be operated as a DMS that provides contents for itself, or as a DMR or a DMP, which play contents provided by other devices. A device playing contents is referred to as a renderer in embodiments of the present invention.

If the content sharing function is selected in the user terminal device 100 of FIG. 1, the user terminal device 100 searches each device 10, 20, 30, 40 which is connected to a network and requests content information. Specifically, the user terminal device 100 broadcasts a signal requesting the information through the AP. Each device 10, 20, 30, 40 which receives the signal requesting the information through the AP transmits a response signal including their own information. The user terminal device 100 can obtain information on contents by connecting to each device using the information on each device. A device corresponding to a DMS to provide contents among the devices 10, 20, 30, 40 which are connected to a network notifies information on contents which the device can provide to the user terminal device 100, which acquires detailed information on contents using SOAP (Simple Object Access Protocol) based on the notified content information.

The user terminal device 100 displays the acquired detailed information on contents so as to enable a user to select one of the contents. When the user selects one content, the user terminal device 100 requests a content transmission to DMS in which the selected content is stored. The DMS transmits the requested content using HTTP (Hypertext Transfer Protocol).

The user can select a renderer to play a content provided by the DMS.

If a first device 10 is selected as a DMS and a second device 20 is selected as a renderer in the system of FIG. 1, the user terminal device 100 may receive contents from the first device 10 and send the contents to the second device 20, or control the first device 10 to send the contents directly to the second device 20.

The second device 20 plays the provided contents. An operation of the second device 20 is controlled by a DMC, the role of which is played by a selected device in the content sharing system of FIG. 1. In addition to performing as the content sharing function, the user terminal device 100 may also perform as the DMC.

If the user terminal device 100 performs the function of the DMC, the user terminal device 100 displays a control UI, on which is displayed an object image. A user can touch or drag the object image, which accordingly may change in shape and display position-, for example. The object image returns to the original position and the original shape when the user's touch or drag terminates. The user terminal device 100 performs a control operation corresponding to a user's manipulation of the object image.

For example, when video content is being played, the user terminal device 100 can control the renderer 20 to raise the volume when the object image is dragged upward. If dragging of the object image terminates, it returns to the original state and the state of raised volume is maintained.

If the object image is flicked to the right, the user terminal device 100 may control the renderer 20 to play the next video content.

Various control operations may be performed according to manipulations of the object image.

As described above, since the control operations are performed by manipulating the object image, a user can easily control an operation of the renderer 10 without continuously watching a control UI displayed in the user terminal device 100.

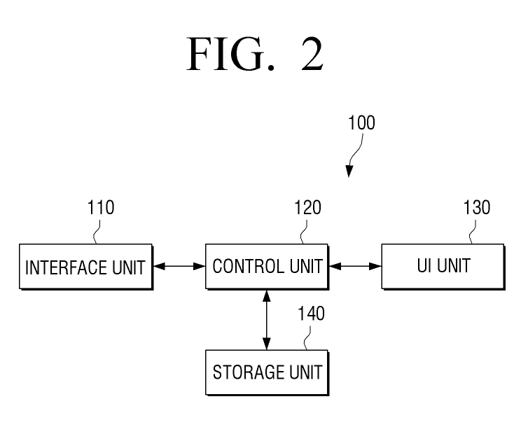

FIG. 2 illustrates a user terminal device 100 according to an embodiment of the present invention. Referring to FIG. 2, the user terminal device 100 comprises an interface unit 110, a control unit 120, a UI unit 130, and a storage unit 140.

The interface unit 110 is connected to a network. If it is constituted as the content sharing system of FIG. 1, the interface unit 110 may be connected to each device 10, 20, 30, 40 through an AP. For instance, the interface unit 110 may be connected to a network by using mobile communication protocol or Wireless Fidelity (Wi-Fi) protocol.

The UI unit 130 may display various forms of UI, including a control UI. If the UI unit 130 includes a touch screen, a user may input various user commands by touching the control UI of the UI unit 130. If the UI unit 130 does not include a touch screen, the user may control an object image of the control UI using at least one key provided in a main body of the user terminal device 100, or various input means such as a mouse, keyboard or joystick which are connected to the user terminal device 100.

The storage unit 140 stores contents or various programs. Various types of multimedia contents including video, photo, and music may be stored in the storage unit 140, along with information about manipulations of the object image and control operations corresponding to the object image manipulations.

The control unit 120 performs a variety of functions by controlling an operation of the user terminal device 100 in accordance with a user command. If the content sharing function is selected, the control unit 120 searches contents that can be shared. If one content is selected from the searched contents and a renderer is selected, the control unit 120 controls the UI unit 130 to display the control UI. If the object image is manipulated in the control UI, the control unit 120 confirms information on a control operation corresponding to the manipulation from the storage unit 140 and performs the confirmed control operation.

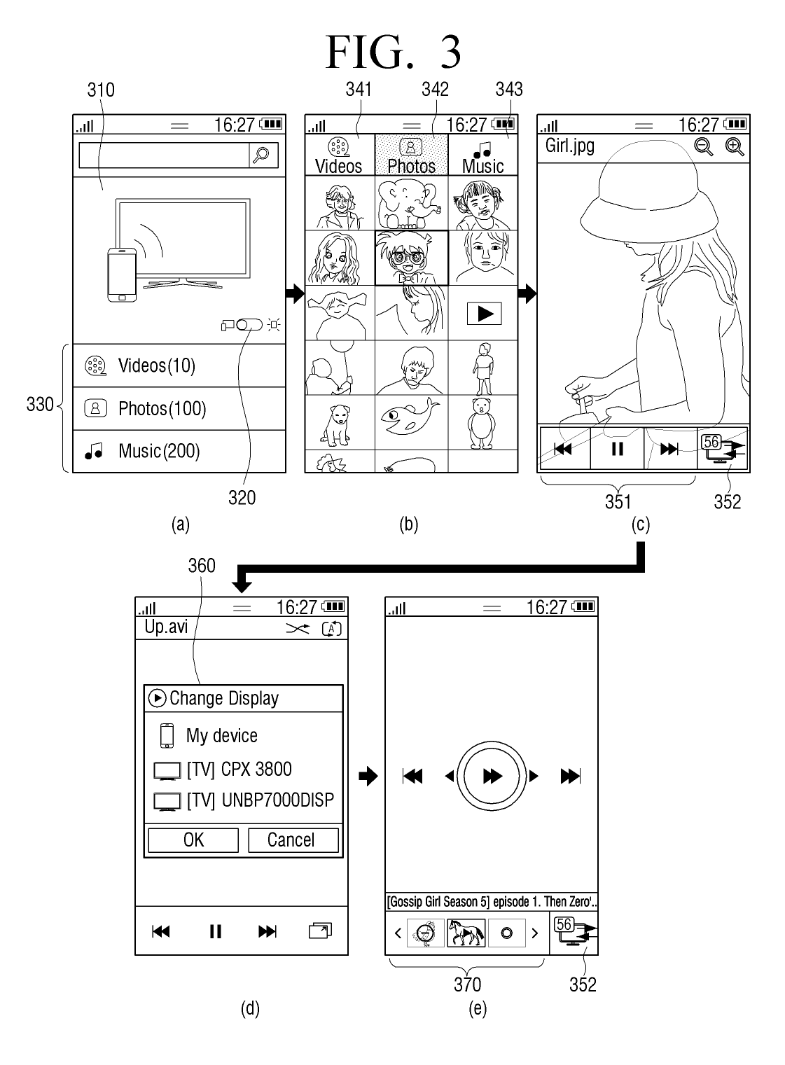

FIG. 3 illustrates an example of a UI constitution to perform a content sharing function. If the content sharing function is performed, the user terminal device 100 displays UI (a) including an image 310, a mode selection menu 320, and an information display area 330, which correspond to the content sharing function.

The image 310 corresponding to the content sharing function may be a preset and stored image. When the content sharing function is performed by a user terminal device that can be selected from a local mode and a network mode, the image 310 corresponding to a default mode is displayed in an initial UI screen. FIG. 3 illustrates a state of displaying the image 310 corresponding to the local mode.

The mode selection menu 320 is displayed when the user terminal device 100 supports both the local mode and the network mode. In other words, a user may select one of the modes by adjusting the mode selection menu 320 left or right.

In the case of examples that do not support a mode selection, the mode selection menu 320 may be omitted.

The information display area 330 shows contents divided into categories. A user can select a category in the information display area 330.

If the user selects a photo category, contents included in the photo category are displayed in the UI (b), such as by thumbnails. Taps 341, 342, 343 corresponding to each category may be displayed in a upper part of the UI.

If one content is selected in the UI (b), the content is played on a screen (c) of the user terminal device 100. Various menus 351 to input play/stop and change of contents, and a menu 352 to select a renderer may be displayed in a lower part of the playing screen (c). The menu 352 to select a renderer may display the number of renderers that are connected to a current network.

The menu 352 can be displayed in various formats. For instance, if the menu 352 is selected, a list 360 which can select a renderer is displayed on the UI (d).

When a connection between the user terminal device 100 and an AP is lost, there may be a change to a screen selecting the AP if the menu 352 is selected.

Although the user terminal device 100 is connected to the AP, if a renderer that can share contents is not involved on a network, re-searching may be performed.

If the user terminal device 100 is connected to the AP and a renderer is involved on a network, a list of the renderer is provided by a pop-up as shown in FIG. 3 (d).

If a user selects one renderer, control UI (e) is displayed. Control menus varying depending on content types may be displayed in a lower part of the control UI (e), which illustrates a state of displaying a thumbnail view 370. The thumbnail view 370 gives a relevant mark respectively to an inactive content, a content currently being played, and a content being loaded, and enables the user to easily understand a current state of contents. The menu 352 to select a renderer is displayed on one side of the thumbnail view 370 (e). In other words, the user can change the renderer by selecting the menu 352 even while selecting the renderer and playing a content.

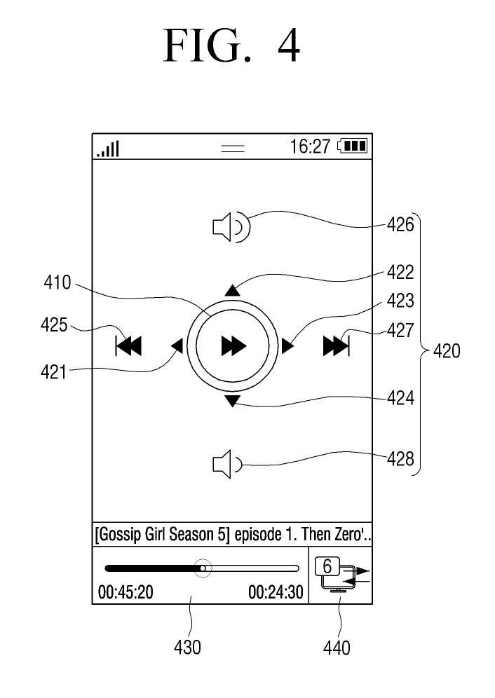

FIG. 4 illustrates a constitution of control UI according to an embodiment of the present invention. Referring to FIG. 4, the control UI displays an object image 410, an indicator 420, a message area 430, and a bar graph 440.

The object image 410 is displayed in a button form in the center of the control UI.

Each of the indicators 420 is arranged on the side of top, bottom, left, and right on a basis of the object image 410. FIG. 4 illustrates eight indicators (421, 422, 423, 424, 425, 426, 427, 428) in total. It may be possible for the indicators (421, 422, 423, 424) which are displayed in an arrow shape on the side of top and bottom, or left and right so as to indicate a moving direction of the object image 410 and the indicators (425, 426, 427, 428) which are to notify an operation performed when moving in such a direction to be displayed together. FIG. 4 illustrates eight indicators 420. However, the number of the indicators 420 may vary depending upon various environments such as content types and renderer operations. In other words, two arrow shaped indicators may be displayed on the side of top and bottom, or left and right, or eight arrow shaped indicators and eight indicators for representing their functions may be displayed diagonally in addition to on every side as above.

The bar indicator 430 shows a progress of playing contents. When contents such as video or music, which are played for a certain time, are played in a renderer, the control UI may display the bar indicator 430 as shown in FIG. 4.

A length of the bar indicator 430 varies depending upon user manipulations, and accordingly a content playing point of time changes in the renderer. A current play time is displayed on the right side of the bar indicator 430 and a remaining time until a content finishes being played is displayed on the left side of the bar indicator 430. A menu that can change the renderer 440 is displayed on one side of the bar indicator 430.

Control operations corresponding to forms of the indicators 420, display positions of the indicators 420 and manipulations of the indicators 420 may vary depending on content types.

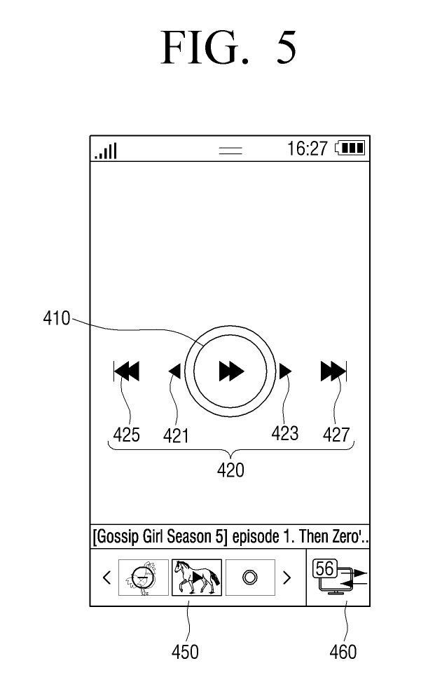

As to photo contents, a playing point of time need not be displayed. Accordingly, if the photo contents are displayed in the renderer, the control UI as shown in FIG. 5 may be displayed.

Referring to FIG. 5, thumbnail images 450 of other photo contents are displayed on a lower side of an object image in the control UI. A user may select one image from the thumbnail images. If one of the thumbnail images 450 is selected, the selected thumbnail image is displayed in the renderer. The thumbnail images 450 aligned on the lower side of the object image are scrolled to the left or to the right by the user's manipulation. Accordingly, the user may easily select an image to be displayed in the renderer. A menu 460 which can select a renderer is displayed on one side of the thumbnail images 450.

The indicators of FIGS. 4 and 5 may be displayed continuously or fixedly while the control UI is displayed.

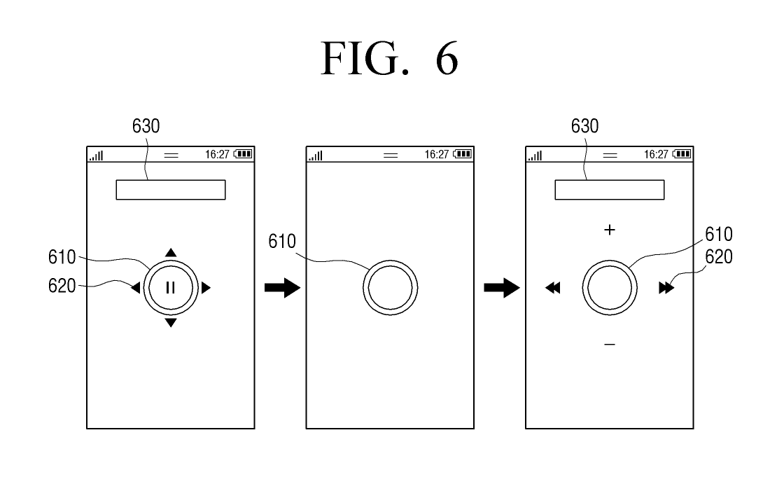

FIG. 6 illustrates a constitution of a control UI and an operation thereof according to an embodiment of the present invention. Referring to FIG. 6, an object image 610 is arranged in the center of the control UI. An indicator 620 and a message area 630 are displayed in a position adjacent to the object image during a preset time after the control UI is initially displayed.

The message area 630 is displayed on an upper side on a basis of the object image 610. In the message area 630, a text is displayed to explain a control operation performed by movements of the object image.

Then, the display of the indicator 620 and the message area 630 disappear, are displayed moving to a position separated from the object image 610, and disappear after a preset time. An initially displayed indicator 620 is an image that displays directionality only, but the indicator 620 displayed being separated from the object image 610 is changed to an image of a form corresponding to a control operation.

The message area 630 is displayed during a preset time together with the indicator 620, and then disappears. Thereafter, the message area 630 is displayed during a preset time, and then disappears even when the object image moves and a control operation is performed.

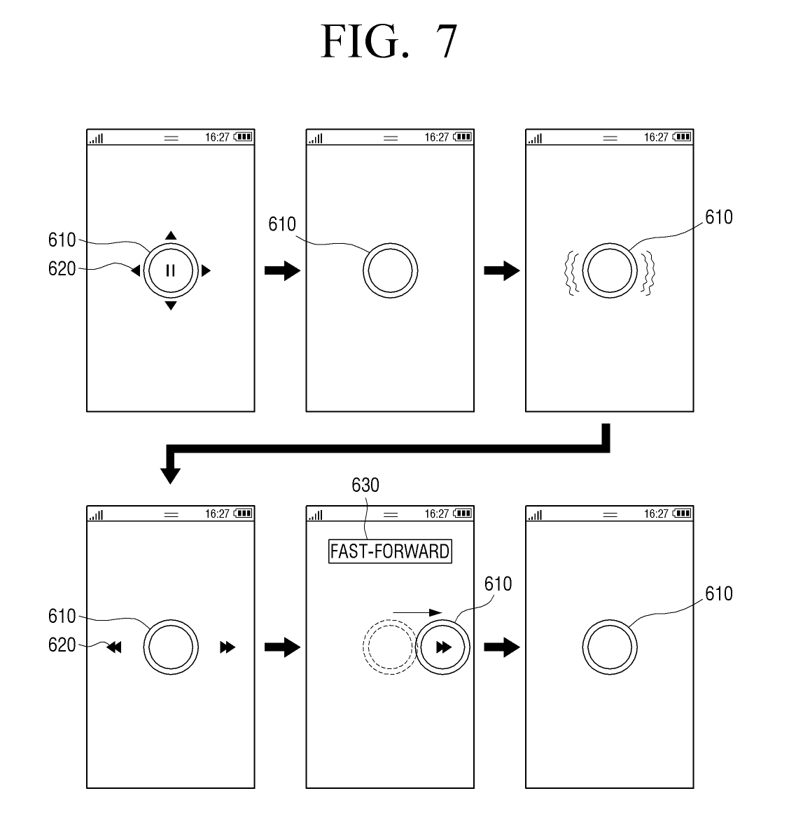

FIG. 7 illustrates a constitution of a control UI and an operation thereof according to an embodiment of the present invention. Referring to FIG. 7, the indicator 620 is displayed adjacent to the object image 610, and then disappears. If the object image 610 is not touched during a preset time, it is displayed as shaking vertically or horizontally in a default position within the control UI, as shown in the upper right illustration. By such a vibration display of the object image 610, the user can easily understand that a position can be changed by touching the object image 610. The indicator 620 is thereafter displayed flicking on a regular basis in a state of being separated from the object image 610. In FIG. 7, the indicator 620 is displayed only on the left and right of the object image 610.

In such a state, if a user drags the object image 610 to the right as shown in FIG. 7, a text corresponding to the moving direction, namely “fast-forward”, is displayed in the message area 630, as shown in the lower center illustration. At this moment, an image corresponding to the fast-forward may be displayed inside the object image 610 while the object image 610 is dragged. The image displayed in the object image 610 may be formed as the indicator 620 of the direction in which the object image 610 moves, but it is not always limited thereto.

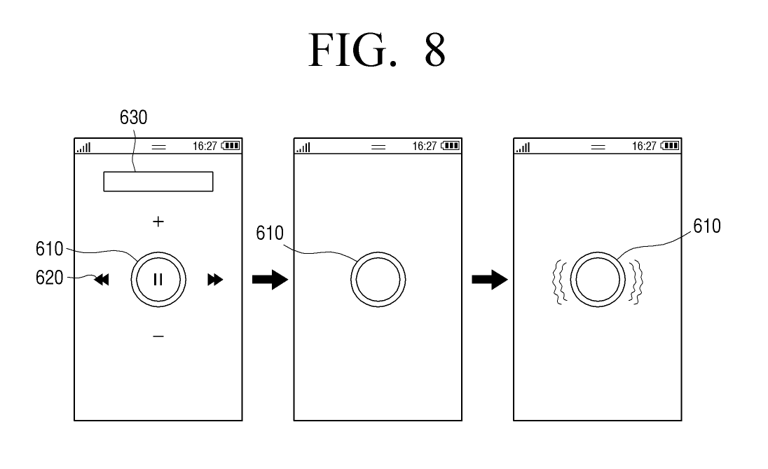

FIG. 8 illustrates a constitution of a control UI and an operation thereof according to an embodiment of the present invention. Referring to FIG. 8, the indicator 620 and the message area 630 are displayed for a moment and disappear at the beginning of displaying the control UI. Thereafter, the indicator 620 is not displayed and the object image 610 is displayed vibrating on a regular basis, as shown in the right-most illustration.

According to embodiments described above, since the indicator 620 is not displayed fixedly and changes in various manners, a user can avoid misinterpreting an indicator as a button.

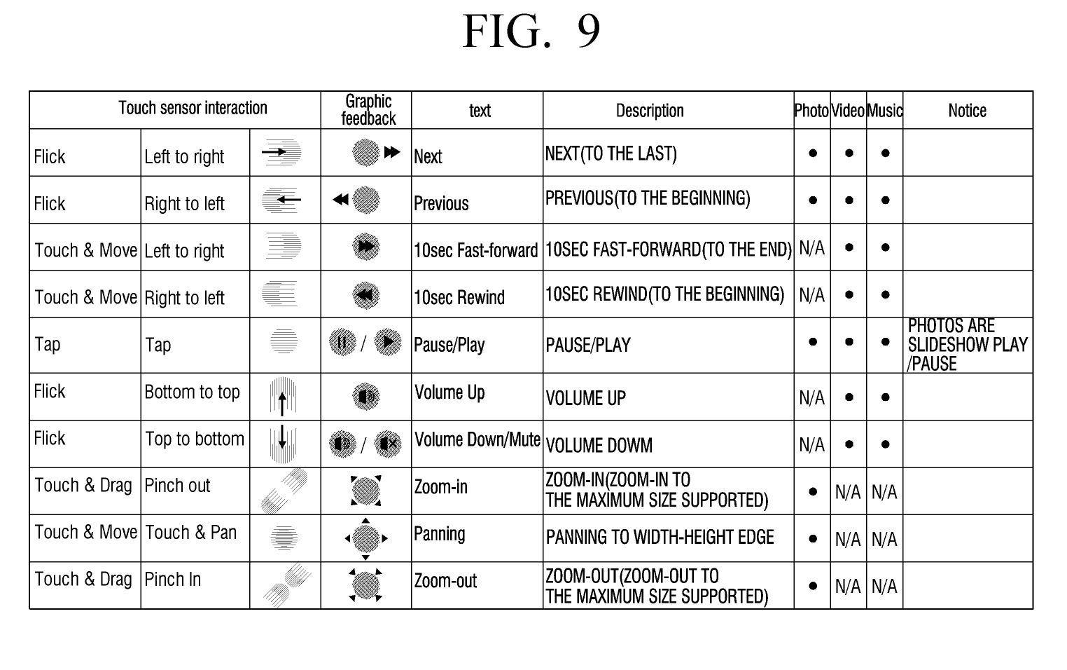

FIG. 9 illustrates various methods for manipulating an object image and an example of a control operation corresponding to the methods. In FIG. 9, “Touch sensor interaction” indicates names of manipulating operations and manipulating directions, and “Graphic feedback” indicates display changes of graphs shown on the control UI when a relevant manipulating operation is performed. In addition, “text” is a text displayed in a message area, and “Description” is a brief explanation on a control operation according to a relevant manipulating operation. Photo, video, and music refer to content types to which the manipulating operations are applied. “Notice” provides other explanations about the manipulating operations and the control operations.

The bar indicator 430 as illustrated in FIG. 4 and the thumbnail image as illustrated in FIG. 5 can be applied equally to the various forms of control UI as illustrated in FIGS. 6 to 8.

As illustrated in FIG. 9, if an object image is flicked from left to right, a graphic feedback that displays [symbol] on the right side of the object image is made in the control UI, and a text such as “Next” is displayed in the message area. And then, a control operation that changes to the next content is performed. If a flick is made from right to left, a text such as “Previous” is displayed in the message area and a control operation that changes to the previous content is performed. Content changes made by flick operations can be applied to all of photos, videos, and music.

If Touch and Move is made, wherein an object image moves slowly from left to right while being touched and the touch is maintained for a period of time, a graphic feedback that displays arrows such as [symbol] inside the object image is made, and fast-forward is performed as a unit. If Touch and Move is made in the opposite direction, arrows such as [symbol] are displayed inside the object image and rewind is performed as a unit of time. In FIG. 9, the fast-forward and the rewind are performed every ten seconds, but it is not always limited thereto. The fast-forward and the rewind may not be applied to photos.

If a user can perform the fast-forward and the rewind using the bar indicator 430 as illustrated in FIG. 4, it may not be necessary to perform a control operation as to Touch and Move, or other control operations except for the fast-forward and the rewind may be matched to Touch and Move. Therefore, as to embodiments in which the bar indicator 430 is not applied, as illustrated in FIG. 9, the fast-forward and the rewind may be performed by Touch and Move.

Further, the user may perform a tap operation touching more than once or twice without dragging the object image 410 to one side. If the tap operation is performed, an image II corresponding to pause or an image [symbol] corresponding to play is displayed inside the object image 410, a text such as Pause or Play is displayed in the message area, and an operation of pause or play is performed. Such a display state and control operation are made alternately every time the tap is repeatedly performed. If a photo content is displayed, pause or play is not involved, and thus a control operation such as a slide show play or stop can be matched to the tap.

Further, the user flicks from bottom to top or from top to bottom, an image corresponding to volume up or volume down, a text is displayed in each place, and an operation of the volume up or volume down is performed. The control operation is applied to photos.

If a user performs Touch and Drag which touches an object image with two fingers, and then spreads or narrows bi-directionally, a mark to notify zoom-in or zoom- out is displayed around the object image and a text such as “Zoom-in” or “Zoom-out” is displayed in the message area. A photo that is output in a renderer is enlarged or reduced.

If the photo is enlarged by zoomed-in, the user can perform Touch and Move wherein an object image is touched and moves to one side. In this case, a position of the enlarged photo moves. A text such as “panning” is displayed in the message area, and a mark such as an arrow is displayed around the object image. The operations including zoom-in, zoom-out, and panning are applied only to photos, and not to videos and music.

As illustrated in FIG. 9, the manipulations of the object image may be stored while matched to various control operations.

In embodiments described above, an object image itself is touched and manipulated. The touching of a certain point of the area of the control UI is touched, namely, an area except for the object image, indicates manipulation of the object image, and thus the operation as illustrated in FIG. 9 can be performed in accordance with being touched or a moving direction of a touched point. Also, the manipulation of the object image and the example of the control operation matched thereto are not limited to the illustration in FIG. 9.

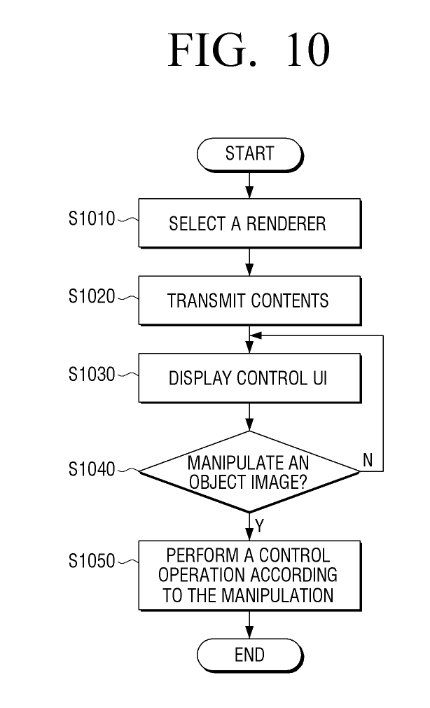

FIG. 10 explains a method for controlling a content device according to an embodiment of the present invention. Referring to claim 10, if a renderer is selected in the user terminal device in step S1010, content is transmitted to the selected renderer in step S 1020. A process of selecting content may be performed before or after selecting the renderer, or may be embodied as a working example of immediately transmitting content currently being played without a selection.

If content is transmitted, a control UI is displayed in the user terminal device in step S1030.

The control UI displays an object image. A user can manipulate the object image in various directions by touching in step S1040.

If the object image is manipulated, a renderer is controlled by sending the renderer a control signal to make a control operation perform according to the user's manipulation in step S1050.

The control UI can be embodied in various forms as illustrated in FIGS. 4 to 8. A constitution and an operation of the control UI are described in detail in the above portions in relation to FIGS. 4 to 9, and thus an explanation that repeats the above is omitted.

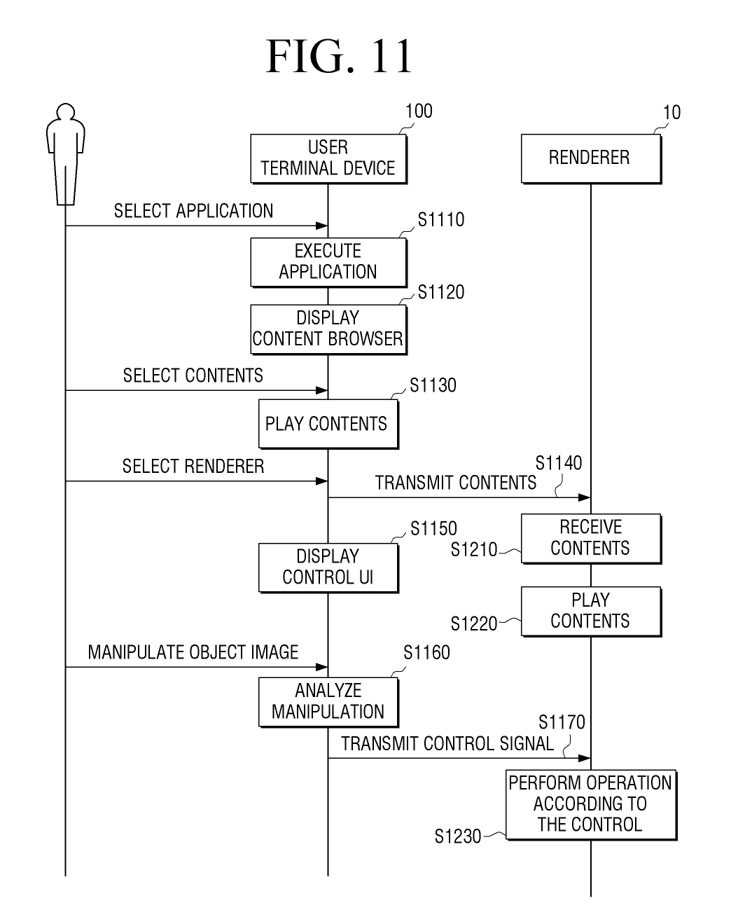

FIG. 11 explains more specifically a method for controlling a content device according to an embodiment of the present invention.

Referring to FIG.11, if a user selects an application in the user terminal device, the user terminal device executes the selected application in step S1110. The application may be an application to execute a content sharing function.

If the application is executed, the user terminal device 100 displays a browser regarding relevant content in step S1120. The browser refers to a UI which searches content stored in devices connected in the user terminal device 100 or a network and displays the content. A user can select content by the content browser.

If content is selected, the user terminal device 100 plays the selected content in step S1130. In this state, if the user selects a renderer, the user terminal device 100 transmits the content to the selected renderer in step S1140.

In this case, if the content is provided by a DMS connected to a network, the user terminal device 100 sends the DMS a control signal commanding a transmission of the content to the renderer, and thus can control so that DMS can directly send the content.

In the content sharing system as illustrated in FIG. 1, if the first device 10 is selected as a renderer, the renderer 10 receives content from the user terminal device 100 or DMS in step S1210, and then plays the content in step S1220. The played content may be various types of multimedia contents such as videos, photos and music.

If the content is played in the renderer, the user terminal device 100 displays a control UI in step S1150. The control UI is for controlling an operation of the renderer 10. The control UI displays an object image, which is manipulated by a user.

When the object image is manipulated by the user, the user terminal device 100 analyzes the manipulation in step S1160. If analysis confirms that a control operation is matched to the manipulation, a control signal is transmitted to perform the confirmed control operation in step 51170. The renderer 10 receives the control signal and performs an operation according to the control signal in step S1230.

FIG. 11 includes step S1130 of playing the selected content in the user terminal device, but in accordance with embodiments, the content is not played in the user terminal device, and a list to select a renderer may be immediately displayed.

The constitution and operation method of the control UI are described in detail in the above, and thus an explanation repeating the above is omitted.

A user can manipulate an object image although touching a certain area in the control UI without accurately touching the object image. In this case, forms or display positions of the object image vary depending on movements of touched points and a message area displays a text corresponding to the variation.

Meanwhile, a UI provided when executing a content sharing function may be displayed in a constitution different from the illustration in FIG. 3.

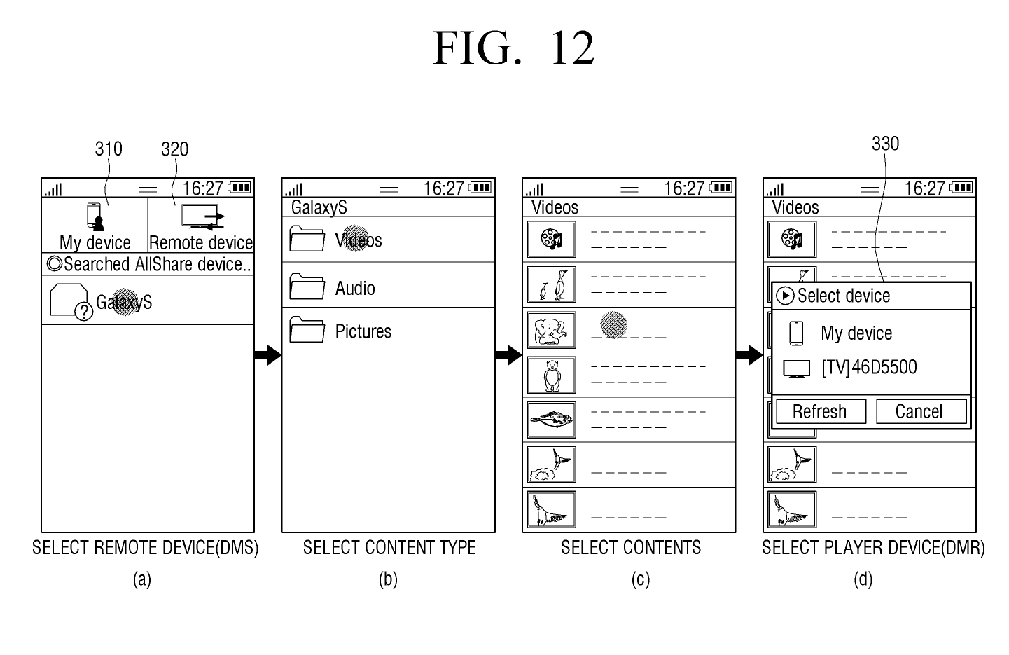

FIG. 12 illustrates an example of a UI according to an embodiment of the present invention.

Icons for applications installed in the user terminal device 100 are displayed on a background image. If a user selects an icon corresponding to a content sharing function, a UI of FIG. 12 is displayed.

Referring to FIG. 12, the UI displays UI (a) including a tap 310 to search contents stored in the user terminal device 100 and a tap 320 to search remote devices.

If the tap 320 to search remote devices is selected, UI (a) displays devices connected to a network, which are searched by the tap 320. Under this state, if a user selects one device, UI (b) displays categories that divide contents stored in the selected device.

If the user selects one category, UI (c) displays contents included in the selected category. The contents of FIG. 12 are displayed in a list, and may be displayed as a thumbnail image.

If the user selects contents, UI (d) including the list 330 of a renderer is displayed.

If the user selects the renderer on the list 330, contents are provided to the selected renderer. The user terminal device 100 displays a control UI if a renderer is selected.

If the tap 310 is selected, contents stored in the user terminal device 100 are searched. The searched contents are divided into categories and are displayed as illustrated in FIG. 12. A mode that searches the contents stored in the user terminal device 100 may be referred to as a local mode. On the contrary, a mode that searches contents of devices connected to a network may be referred to as a network mode.

If the tap 310 is selected and is operated as a local mode, the user terminal device 100 functions as a DMS. When operated as a local mode, access to other DMSs and content information loading are not performed, which reduces the process time. In the local mode, it is not possible to browse or library for other devices, but it is possible to have a rendering function which makes it possible to play by providing a renderer with contents or a control function which controls a playing state. In other words, the user terminal device can perform a DMC function.

A user selects a tap as necessary and can conveniently select a local mode and a network mode. In FIG. 12, a UI is displayed equally for a selected tap, but according to embodiments, the UI may vary depending on modes. In other words, the local mode may display a local mode UI and the network mode may display a network mode UI. The local mode UI and the network mode UI are formed differently from each other and display searched contents.

As described above, a user can easily control operations of a renderer that is provided with contents without continuously watching a screen of the user terminal device 100. The control operations of the renderer vary depending on at least one of moving direction, moving speed, time of touch manipulation, and touch method of an object image.

Programs to perform the method according to embodiments of the present invention may be stored in various types of recording media and used.

Specifically, codes to execute the described methods may be stored in various types of terminal-readable recording media including RAM (Random Access Memory), flash memory, ROM (Read Only Memory), EPROM (Erasable Programmable ROM), EEPROM (Electronically Erasable and Programmable ROM), register, hard disk, removable disk, memory card, Universal Serial Bus (USB) memory, CD-ROM, and the like.

The foregoing embodiments and advantages are not to be construed as limiting the present invention, which can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method for controlling a renderer of a user terminal device, the method comprising:
selecting a renderer which shares contents;
transmitting the contents to the selected renderer;
displaying a control User Interface (UI) including an object image of which position moves according to a user's touch manipulation; and
performing a control operation which controls the renderer in accordance with movements of the object image on the control UI.

2. The method as claimed in claim 1, wherein the control operation varies depending on at least one of moving direction, moving speed, time of touch manipulation, and touch method of the object image.

3. The method as claimed in claim 2, wherein the control UI comprises at least one indicator that is displayed in a direction with the object image at a center of the UI as an image corresponding to an operation of the renderer.

4. The method as claimed in claim 3, wherein the control UI further comprises a message area that displays a control operation performed by movements of the object image as a text.

5. The method as claimed in claim 4, wherein the at least one indicator is fixedly displayed in at least one position of top, bottom, left and right of the UI with the object image being displayed at the center of the UI.

6. The method as claimed in claim 4, wherein the at least one indicator is displayed in at least one position of top, bottom, left and right of the UI with the object image being displayed at the center of the UI during a preset time and then disappears, and
wherein the message area is displayed during a preset time and disappears when the object image moves and the control operation is performed.

7. The method as claimed in claim 4, wherein the at least one indicator is displayed in a position adjacent to the object image in at least one direction of top, bottom, left and right of the UI with the object image being displayed at the center of the UI during a preset time and then disappears after being displayed moving to a position separated from the object image, and flicks a preset number of times, and
wherein the message area is displayed during a preset time and disappears when the object image moves and the control operation is performed.

8. The method as claimed in claim 7, wherein the object image is displayed in a vibrating manner in a default position within the control UI if the object image is not touched during a preset time.

9. The method as claimed in claim 4, wherein a form of the indicator, a display position of the indicator, the control operation, and a text displayed in the message area vary depending on types of the contents.

10. The method as claimed in claim 1, further comprising controlling to pause playing if the object image is tapped while the contents are transferred to the renderer and are played, and to resume playing if the object image is tapped during the pause.

11. The method as claimed in claim 1, wherein when an area of the control UI is touched the object image moves according to a moving direction and a moving trace of the touched area.

12. The method as claimed in claim 1, wherein when the object image of the control UI is touched, the object image moves according to a moving direction and a moving trace of the touched area.

13. The method as claimed in claim 1, further comprising:
displaying a background image;
displaying, when an icon corresponding to a content sharing function is selected on the background image, contents stored in the user terminal device and at least one device of other devices connected to a network;
playing, when content is selected from the displayed contents, the selected content; and
displaying a device list when a renderer selection menu is selected.

14. The method as claimed in claim 1, further comprising:
displaying a background image;
displaying, when an icon corresponding to a content sharing function is selected on the background image, contents stored in the user terminal device and at least one device of other devices connected to a network; and
displaying a device list to select a renderer, when content is selected from the displayed contents.

15. The method as claimed in claim 1, wherein performing the control operation performs one of a change to next content, a change to previous content, fast-forward, rewind, pause, play, volume up, volume down, zoom-in, panning, and zoom-out according to manipulations of the object image.

16. The method as claimed in claim 1, wherein when the content is videos or music, a bar indicator showing a progress of playing the content is displayed on a lower side of the object image within the control UI, and
wherein a playing point of time of the content changes in the renderer according to manipulations of the bar indicator.

17. The method as claimed in claim 1, wherein when the content is photos, thumbnail images of other photos are displayed on a lower side of the object image within the control UI, and
wherein when one image is selected from the thumbnail images, the selected thumbnail image is displayed in the renderer.

18. A user terminal device comprising:
a storage unit which stores contents;
a User Interface (UI) unit which outputs a UI from which a renderer is selected to share the contents;
an interface unit which transmits the contents to a renderer selected in the UI; and
a control unit which, when the contents are transmitted, controls the UI unit to display a control UI including an object image of which position moves according to a user's touch manipulations,
wherein when the object image moves on the control UI, the control unit performs a control operation which controls the renderer in accordance with the object image movements.

19. The user terminal device as claimed in claim 18, wherein the control operation varies depending on at least one of moving direction, moving speed, time of touch manipulation, and touch method of the object image.

20. The user terminal device as claimed in claim 19, wherein the control UI comprises at least one indicator that is displayed in a given direction with the object image at a center of the UI as an image corresponding to an operation of the renderer.

21. The user terminal device as claimed in claim 20, wherein the control UI further comprises a message area that displays a control operation performed by movements of the object image as a text.

22. The user terminal device as claimed in claim 21, wherein the at least one indicator is fixedly displayed in at least one position of top, bottom, left and right of the UI with the object image being displayed at the center of the UI.

23. The user terminal device as claimed in claim 21, wherein the at least one indicator is displayed in at least one position of top, bottom, left and right of the UI with the object image being displayed at the center of the UI during a preset time and then disappears, and
wherein the message area is displayed during a preset time and disappears when the object image moves and the control operation is performed.

24. The user terminal device as claimed in claim 21, wherein the at least one indicator is displayed in a position adjacent to the object image in at least one direction of top, bottom, left and right of the UI with the object image being displayed at the center of the UI during a preset time and then disappears after being displayed moving to a position separated from the object image, and flicks a preset number of times, and
wherein the message area is displayed during a preset time and then disappears when the object image moves and the control operation is performed.

25. The user terminal device as claimed in claim 24, wherein the object image is displayed in a vibrating manner in a default position within the control UI when the object image is not touched during a preset time.

26. The user terminal device as claimed in claim 20, wherein a form of the indicator, a display position of the indicator, and an operation corresponding to the indicator varies depending on types of the contents.

27. The user terminal device as claimed in claim 18, wherein the control unit controls the renderer so as to pause playing when the object image is tapped while the contents are transferred to the renderer and are played in the renderer, and to resume playing when the object image is tapped during the pause.

28. The user terminal device as claimed in claim 18, wherein when an area of the control UI is touched, the object image moves according to a moving direction and a moving trace of the touched area.

29. The user terminal device as claimed in claim 18, wherein when the object image of the control UI is touched, the object image moves according to a moving direction and a moving trace of the touched area.

30. The user terminal device as claimed in claim 18, wherein when an icon corresponding to a content sharing function is selected on the background image of the display unit, the control unit controls the UI unit so as to display contents stored in the storage unit and at least one device of other devices connected to a network,
wherein when content is selected from the displayed contents, the control unit plays the selected content and outputs the same,
wherein when a renderer selection menu is selected while the selected content is being played, the control unit controls the UI unit to display a device list.

31. The user terminal device as claimed in claim 18, wherein when an icon corresponding to a content sharing function is selected on the background image of the display unit, the control unit controls the UI unit so as to display contents stored in the storage unit and at least one device of other devices connected to a network,
wherein when content is selected from the displayed contents, the control unit controls the UI unit so as to display a device list to select a renderer.

32. The user terminal device as claimed in claim 18, wherein the control operation is determined to be one of a change to next content, a change to previous content, fast-forward, rewind, pause, play, volume up, volume down, zoom-in, panning, and zoom-out according to manipulations of the object image.

33. The user terminal device as claimed in claim 18, wherein when the content is videos or music, the UI unit displays a bar indicator showing a progress of playing the content on a lower side of the object image within the control UI,
wherein the control unit performs a control operation which changes a playing point of time of the content in the renderer according to manipulations of the bar indicator.

34. The user terminal device as claimed in claim 18, wherein when the content is photos, the UI unit displays thumbnail images of other photos on a lower side of the object image within the control UI,
wherein when one image is selected from the thumbnail images, the control unit performs a control operation which displays the selected thumbnail image in the renderer.
